(19) United States
(12) Patent Application Publication
(10) Pub. No.: US 2023/0143503 A1
(43) Pub. Date: May 11, 2023

(54) PREPARATION OF ECO-FRIENDLY FIRE EXTINGUISHER MICROCAPSULES AND APPLICATIONS THEREOF

(71) Applicant: The Hong Kong University of Science and Technology, Hong Kong (CN)

(72) Inventors: Jinglei YANG, Hong Kong (CN); Dan LI, Hong Kong (CN); Ying ZHAO, Hong Kong (CN)

(21) Appl. No.: 17/964,060

(22) Filed: Oct. 12, 2022

Related U.S. Application Data
(60) Provisional application No. 63/272,142, filed on Oct. 26, 2021.

(51) Int. Cl. A62D 1/00; B01J 13/12; C08K 9/10; C09D 5/18; C09D 7/40; H01M 10/42

(52) U.S. Cl. CPC A62D 1/0021; B01J 13/125; C08K 9/10; C09D 5/18; C09D 7/70; H01M 10/4235; H01M 2200/10

(57) ABSTRACT

A method of preparing a fire extinguishing core-shell microcapsule by a one-pot oil-in-oil/ water emulsion technique. The method includes dissolving a fluid fluoroketone or hydrofluorocarbon fire extinguishing core material and a polymer shell material into a volatile solvent to form a composite mixture. The composite solution is emulsified into a polar phase and a non-polar phase by adjusting a concentration of a surfactant or via mechanical agitation to provide interfacial tension tuning. The volatile solvent is evaporated to precipitate a microcapsule having a fire extinguishing material core and a polymer shell. In a further aspect, the method includes incorporating the core-shell microcapsules in a polymer matrix.

### CROSS-REFERENCE OF RELATED APPLICATIONS

This present application claims the benefit of U.S. Provisional Pat. Application No. 63/272,142 filed on Oct. 26, 2021, which is incorporated by reference herein in its entirety.

### FIELD OF THE INVENTION

The preparation method of the microencapsulation of an environmentally friendly fire extinguisher via a solvent evaporation method by one-step emulsion process is disclosed. By integrating fire extinguishing microcapsules into a polymer, silicone rubber or an epoxy matrix, fire extinguishing composites can be manufactured aimed at putting out fires at a very early ignition stage after decapsulation at 60° C.~120° C.

### BACKGROUND OF THE INVENTION

According to the national fire situation report of the year 2020 released by the Fire Rescue Bureau of the Ministry of Emergency Management of China, a total of 252,000 fires were reported nationwide, causing 1,183 deaths and direct property losses up to 0.62 billion dollars. Among all, 33.6% of fires are related to electrical causes. For example, there have been about 50 accidents involving Tesla electric vehicles worldwide including combustion, spontaneous combustion and explosions caused by driving, collisions, and charging. Once spontaneous combustion occurs in an electric vehicle, it will catch fire very quickly; it takes about only ten seconds from initial smoke to fire ignition. Further, electrical fires are predicted to increase in frequency in the future due to the growing electricity consumption. Therefore, there is an urgent need to enhance effectiveness of fire fighting in these scenarios and thus mitigate the potential damage.

Conventionally, gas-based fire extinguishing agents, halogenated hydrocarbon fire extinguishers in particular, are considered as effective means to put out fires in electrical devices, when water or powder fire extinguishers are not applicable. They are stored as liquids in containers under strict pressure conditions with dispersion pipes. The restrictions of existing gaseous fire extinguisher system such as the requirement for a large installation area and the use of complex detection systems narrow their application in limited spaces and medium-to-small devices. Moreover, halogenated hydrocarbons (halons) have been banned by the European Union due to their high impact on ozone depletion resulting in global warming. Therefore, research has been conducted to seek novel strategies for solving these problems.

Efforts have been taken to develop alternatives to gas-based fire extinguishers. Fire extinguishing microcapsules and fire proofing materials are aimed at suppressing fires at a very early stage. Microencapsulation endows fire extinguishing agents with superior storage capability, customizable shell materials, and easy integration with other materials to minimize space.

The current preparation of microencapsulated fire extinguishing agents typically includes interfacial polymerization, gelatin condensation, or curing of a resin shell wall with the help of curing agents. However, these methods may involve multi-step synthesis techniques. Accordingly, it is critical to develop a facile one-pot process with potential for large-scale industrial production to prepare novel environmentally friendly fire extinguisher microcapsules. The present invention addresses this need.

### Description of the Related Art

Yim et al Nano letters 15.8 (2015): 5059-5067 discloses the concept of a self-extinguishing lithium-ion battery by integrating temperature-responsive microcapsules containing a fire extinguishing agent. The microcapsules will open upon increased internal pressure resulting from increased temperature. Then fire extinguishing agent will be released to rapidly cool down the battery. However, the agent used has high biological toxicity.

Zhang et al Materials Advances (2021) discloses a method to obtain a microcapsule containing a clean and safe fire extinguishing agent named perfluoro(2-methyl-3-pentanone) (PFMP) sold as trade name NOVEC 1230 by 3M. It is a fluoroketone having a greater safety margin and much lower environment impact than previous fire extinguishing agents.

Vilesovet al Polymer Science Series A 54.6 (2012): 499-504 discloses a gelatin condensation method to prepare Novec 1230 microcapsules. Based on their preliminary work, Vilesovet al Polymer Science Series B 56.4 (2014): 512-519 discloses a modification method to strengthen the gelatin shell by introducing nanoparticles in the shell formation stage.

These preparation methods cited above typically involve multi-step synthesis. Further, the microcapsules produced may lack sufficient thermal stability and mechanical strength for commercial use.

US4138356A discloses an approach of microencapsulation of flame retardants as alternative means to suppress fire. The walls of the microcapsules consist of a polyhydroxy polymer which reacts with isocyanate in polyurethane foams. Therefore, the flame retardant microcapsules are bonded firmly to the polymer matrix by chemical reactions. However, the as-made microcapsules have average size below 5 microns, meaning that little flame retardant agents are contained in the microcapsules.

RU2469761C1 discloses examples of the application of microcapsules containing Novec 1230 as a fire extinguishing agent. The as-made compositions can be in forms of pastes, plates, films, products, hard foams, fabrics, and fire-extinguishing coatings. In addition, a method for making the fire extinguisher microcapsules is described using gelatin condensation to form a cross-linked polymer shell. However, further improvements on shell quality are needed to enhance thermal stability and storage properties.

JP2020081809A discloses an interfacial polycondensation method to obtain a microcapsule containing a liquid fire extinguishing agent and application thereof as a fire extinguishing sheet and fire extinguishing cord. The fire extinguisher liquid is PFMP. After releasing, it does not damage to electrical devices and has a much lower environmental impact than the other gas-based fire extinguisher agents mentioned above. However, the polymeric shell of polyurea and/or polyurethane is relatively fragile under the mentioned application scenarios. Further, low production efficiency of this method restricts its large-scale application.

KR101733423B1 discloses a gas-based fire extinguishing agent composition that can put out fires at an early initiation stage without requiring pipe or dispersion nozzles. In this invention, halogen-based fire extinguisher microcapsules are wrapped into a polyurea or polyurethane shell based on a polyisocyanate prepolymer. However, the synthesis includes a multi-step process such as prepolymer preparation, shell polymerization and repeated rinse cleaning. Further, poor mechanical strength of the formed microcapsules weakens the mechanical performance of the fire extinguishing composition.

KR102123584B1 discloses a coating type fire extinguishing composition consisting of fire extinguisher microcapsules, polymer resin, precipitating agent, coagulant, and a binder. It is coated on substrates via silkscreen printing technique. The formed microcapsules have controllable size between 1~1000 µm. However, the shell thickness ranges from 50 ~ 2000 nm, making microcapsules susceptible to breakage during a coating process.

CN110025916A discloses a preparation method of fire extinguishing composites containing Novec 1230 as a fire extinguishing agent wrapped inside a polyurethane wall. The composites also include a foam-based double-sided tape as connecting layer and non-woven fabric or kraft paper as the bottom layer. Except for the high biological toxicity during synthesis process, the weak mechanical property is another issue of these composites.

### SUMMARY OF THE INVENTION

The invention discloses a straightforward approach to microencapsulation of an eco-friendly fire extinguisher via a solvent evaporation method to form core-shell particles having a polymer shell and fire-extinguishing core. The preparation of fire extinguisher microcapsules is a novel method based on a one-step “oil-in-oil/water” emulsion system, which makes it distinguishable from conventional multi-step preparation techniques. Using the method of the present invention, the polymer shell materials can be customized according to the different mechanical property requirements for different application scenarios. Importantly, the preparation process is suitable to be scaled for commercial production since it only involves physical agitation during solvent evaporation process.

In one aspect, the present invention provides a method of preparing a fire extinguishing core-shell microcapsule by a one-pot oil-in-oil/water emulsion technique. The method includes dispersing a polymer shell material into a volatile solvent and then mixing it with a fluid fluoroketone or hydrofluorocarbon fire extinguishing core material to form a composite mixture. The composite solution is emulsified into a polar aqueous phase with a certain concentration of surfactant via mechanical agitation to provide interfacial tension tuning. The volatile solvent is evaporated to fabricate a microcapsule having a fire extinguishing material core and a polymer shell.

In a further aspect, the method includes incorporating the core-shell microcapsules in a polymer matrix.

In a further aspect, the volatile solvent is a hydrocarbon solvent.

In a further aspect, the hydrocarbon solvent is one or more of dichloromethane, chloroform, or ethyl acetate.

In a further aspect, the polymer shell is one or more of a polystyrene, a polymethyl methacrylate, a polylactic acid, a polycaprolactone, or a styrenic block copolymer.

In a further aspect, the method of emulsifying the composite solution is carried out under physical agitation in a temperature ranging from 0° C. to 40° C.

In a further aspect, the polymer matrix is selected from one or more of epoxy, polyurethane, polyurea, or silicone rubber.

In a further aspect, the core-shell microcapsules in a polymer matrix are coated onto an electronics or battery component.

### BRIEF DESCRIPTION OF THE DRAWINGS

FIG. 1(a) shows a SEM image of fire extinguishing microcapsules with a distribution of diameters.

FIG. 1(b) shows a SEM image of a single fire extinguishing microcapsule displaying its good ball-shape and smooth surface.

FIG. 1(c) shows a SEM image of a raptured fire extinguishing microcapsule indicating its clear core shell structure.

FIG. 1(d) shows a SEM image of the cross section of the shell of a fire extinguishing microcapsule.

FIG. 2 shows the UV-vis spectrum of fire extinguishing agent and core liquid of typical fire extinguishing microcapsules, demonstrating the successful encapsulation of fire extinguishing agent. The core liquid was obtained from raptured fire extinguishing microcapsules.

FIG. 3 shows the TGA results of typical fire extinguishing microcapsules and polystyrene beads. Accordingly, fire extinguisher agent was decapsulated from 60° C. to 120° C., while the polymer shell decomposed from 420° C. to 450° C.

FIG. 4 shows the function of core content and yield of fire extinguishing microcapsules vs shell-to-core ratio. When the shell-to-core ratio increased to 1:10, the core fraction of as made microcapsules remained steady at about 80%. However, the production yield decreased greatly to 20%.

FIG. 5 shows size distribution of fire extinguishing microcapsules vs agitation rate.

FIG. 6 shows the thermal stability analysis.

FIG. 7 shows the mechanical performance of as made fire extinguishing microcapsules shell by polystyrene, microcapsules shelled by polystyrene with higher polymer molecular weight, and the PUF shelled microcapsule. As demonstrated from the diagram, the mechanical strength of as made microcapsules shelled by polystyrene was much higher than microcapsules shelled by PUF, which was the conventional shell material used in the prior art inventions.

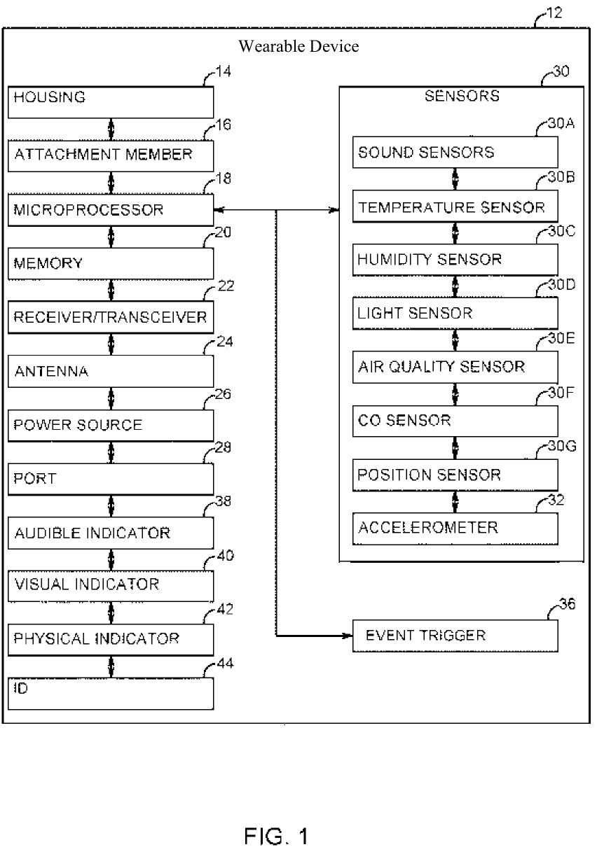

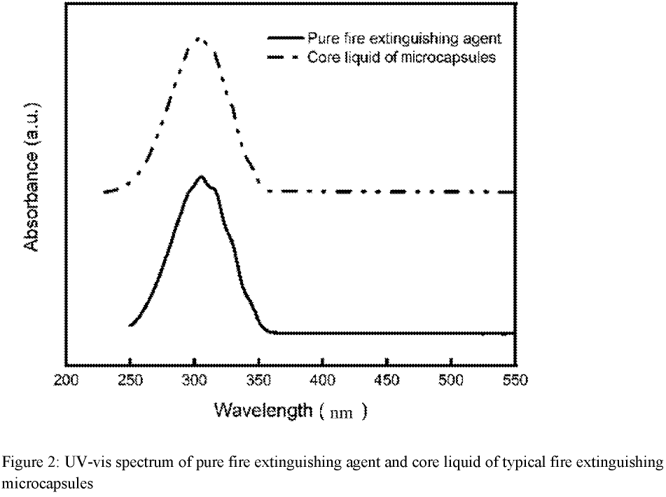

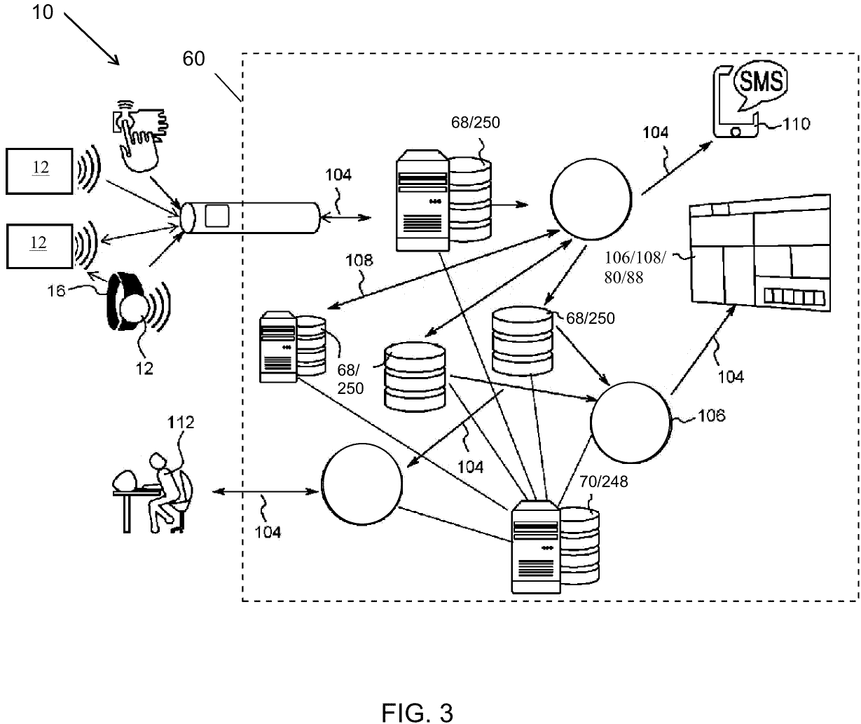

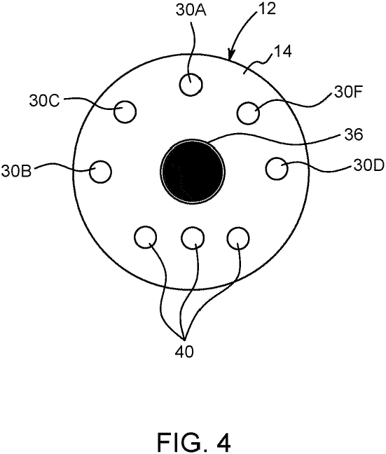

### DETAILED DESCRIPTION

In one aspect, the present invention relates to formation of fire extinguishing core-shell microcapsules. In particular, the microcapsules may be made by a solvent evaporation process. In a solvent evaporation technique, shell materials and core materials are dissolved together into a volatile solvent. The solvent is evaporated using elevated temperature, vacuum, or by continuous stirring. After the complete evaporation of solvent, the polymer materials are precipitated as a solid shell at the interface to wrap the liquid core inside.

Advantageously, the microcapsules are prepared by a one-pot oil in water emulsion technique. As used herein, the expression “one-pot” means a process that can be accomplished in a single reaction apparatus, with various chemical reactions occurring in that single reaction apparatus. Further, the expression “oil-in-oil/water emulsion” relates to a non-polar phase (that is, the “oil” phase which is not necessarily an oil but is any nonpolar material) that is dispersed in a polar phase, typically an aqueous solution (with the polar phase optionally including other materials besides water such as alcohol and other polar solvents).

A fire extinguishing material that is to be the core of the microcapsule is dispersed into a volatile solvent. In the present invention, exemplary fire extinguishing materials include halocarbons; that is, compounds that contain both carbon and one or more halogens (fluorine, chlorine, or bromine). In particular, the selected halocarbons may be fluid fluoroketones or hydrofluorocarbons. Fluoroketones as fire extinguishing agents possess both strong extinguishing capabilities while having zero ozone depletion potential (ODP). In operation, fluoroketones rapidly remove heat and, in this manner, can stop fires before flames erupt. Fluoroketones that may be used include FK-5-1-12 or NOVEC 1230 (3M). Commercially-available hydrofluorocarbon liquids that may be used include 1,1,1,2,3,3,3-Heptafluoropropane, sold under the trade name FM-200 (FIRE TRACE).

A polymer shell material is also dissolved in the volatile solvent along with the fire extinguishing core material. To ensure sufficient mechanical strength of the formed microcapsule, the shell materials are carefully selected for their compatibility with the core fluoroketones or hydrofluorocarbons, their shell-forming capabilities, and the mechanical strength of the shell. Exemplary shell materials include polystyrene, polymethyl methacrylate, polylactic acid, polycaprolactone, or styrenic block copolymers.

Various volatile solvents may be selected for use in the process of the present invention. The solvents are not particularly limited as long as they can accommodate both the selected core material and the selected shell material. Examples of solvents that may be used include dichloromethane, chloroform, or ethyl acetate.

The composite solution including core material, shell material, and solvent, is emulsifies to form a non-polar phase (the so-called “oil” phase) and a polar phase (the so-called “water” phase) through the use of a surfactant. The surfactant is not particularly limited with examples of surfactants including poly(vinyl alcohol) (PVA) and sodium dodecyl sulfate (SDS). By adjusting a concentration of the surfactant, interfacial tension tuning is provided in order to create the emulsification conditions suitable for forming microcapsules of the desired size and strength (as described further in the Examples below). In particular, microcapsules having an average particle diameter of at least approximately 350 microns are formed through the appropriate interfacial tension tuning. Alternatively, emulsification using mechanical stirring may be used. Rates of mechanical stirring result in different microcapsule particle sizes, as described in the Examples below.

The volatile organic solvent is evaporated, through the use of heat, stirring, vacuum or a combination of two or three of these. In an embodiment, the present invention is carried out under physical agitation in a temperature ranging from 0° C. to 40° C. The microcapsules are precipitated during solvent evaporation.

For use in electronic equipment, the core-shell microcapsules may be added to a polymer matrix. The polymer matrix may be one or more of epoxy, polyurethane, polyurea, silicone rubber, or other polymers used in electronic devices or electronic device packaging. In addition, the fire extinguishing microcapsules can be coated onto the commercial separators for lithium-ion batteries to put out flames at the very beginning stage.

### Examples

In the preparation of microcapsules, 1 g polystyrene was dissolved uniformly in 9 g dichloromethane under ultrasound for 30 mins to form 10 wt% polymer solution. After that, the immiscible oil phase is obtained by mixing 5 g fire extinguisher agent in the prepared polymer solution (shell:core = 1:5). The fire extinguisher agent was NOVEC 1230. The resultant oil phase is then emulsified into emulsion droplets under mechanical agitation of 300 rpm to form a stable emulsion in 50 mL of polyvinyl alcohol (PVA) aqueous solution (0.5 wt%). The container used for synthesis is a 200 mL beaker. The beaker was put inside a water bath in advance. After the emulsion system was stabilized for 3mins, ice cubes were added into water bath to make sure the solvent evaporated under 0° C.~5° C. During a 12-hour evaporation of dichloromethane, the polystyrene approaches the oil-water interface and precipitates to form a shell structure, leaving the fire extinguisher agent well encapsulated inside. Subsequently, the formed microcapsules were rinsed by deionized water for several times. After drying in air for 12 hours, the fire extinguisher microcapsules were collected for further characterization.

Under the shell/core ratio of 1:1, 1:3, 1:5 and 1:10, the average core fraction of fire extinguishing microcapsules was 34%, 62%, 79% and 82%. Typical microcapsules used for following characterization have a shell/core ratio of 1:5. The core content and yield of fire extinguishing microcapsules vs shell-to-core ratio is depicted in FIG. 4.

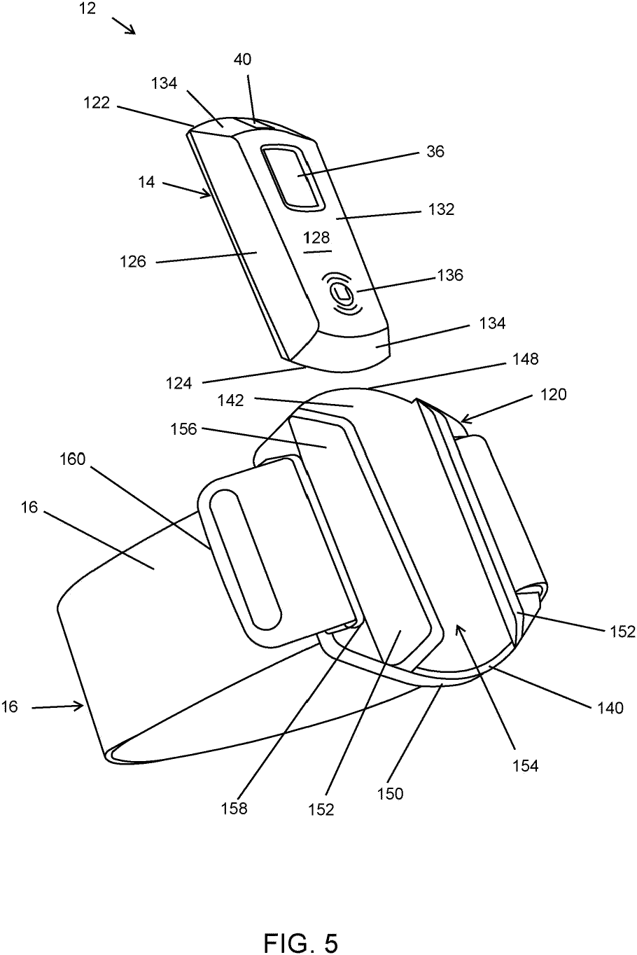

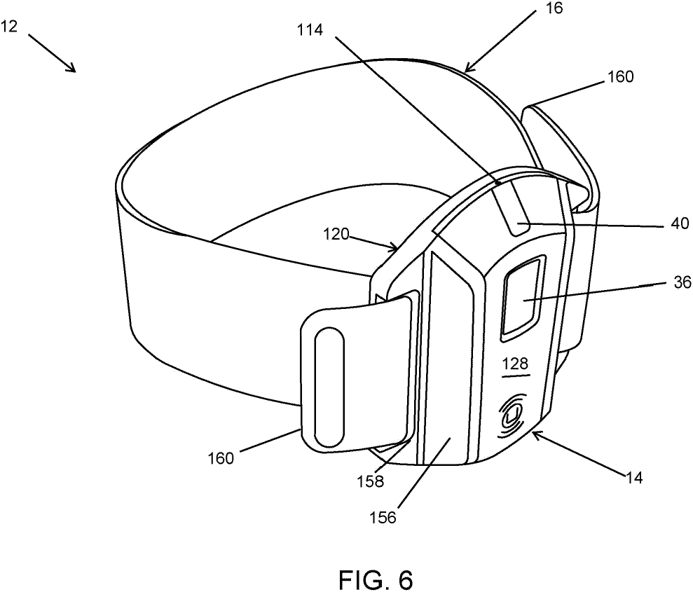

Under agitation rates of 300 rpm, 500 rpm and 800 rpm during solvent evaporation process, the formed fire extinguishing microcapsules have average diameters at 512 µm, 389 µm and 202 µm. Typical microcapsules used for following characterization were manufactured under an agitation rate of 500 rpm. The size distribution of fire extinguishing microcapsules vs the agitation rate during the solvent evaporation process is depicted in FIG. 5.

To test the thermal stability, 1 g of the formed microcapsules were placed in a heating oven at 50° C. As the control group, 1 g of the formed microcapsules were placed in air at room temperature. Additionally, 1 g pure fire extinguishing agent was put in open containers at room temperature and 0° C.~5° C. Every 1 hour, the weights of above samples were measured. The thermal stability was compared based on the weight loss ratio of the microcapsules. The results are depicted in FIG. 6 showing the enhanced thermal stability of the encapsulated fire extinguishing agent as compared to unencapsulated fire extinguishing agents.

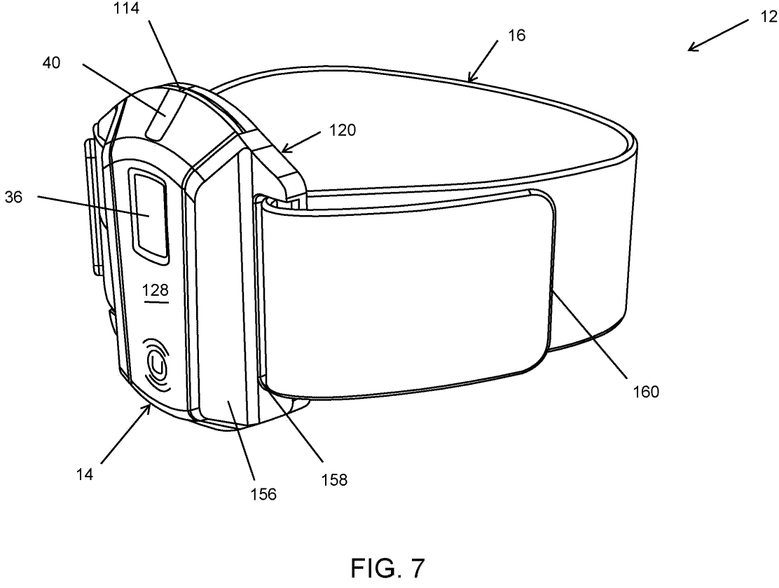

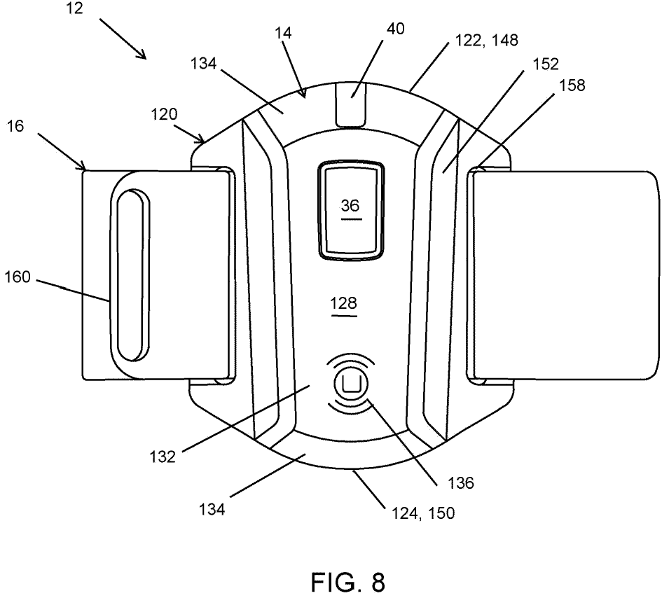

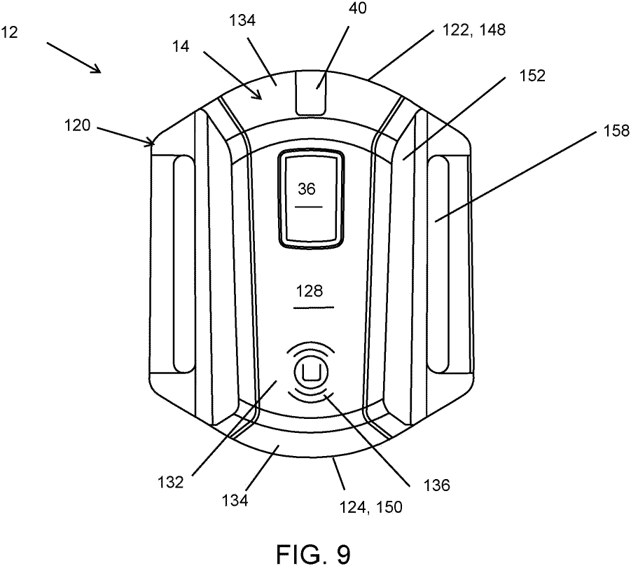

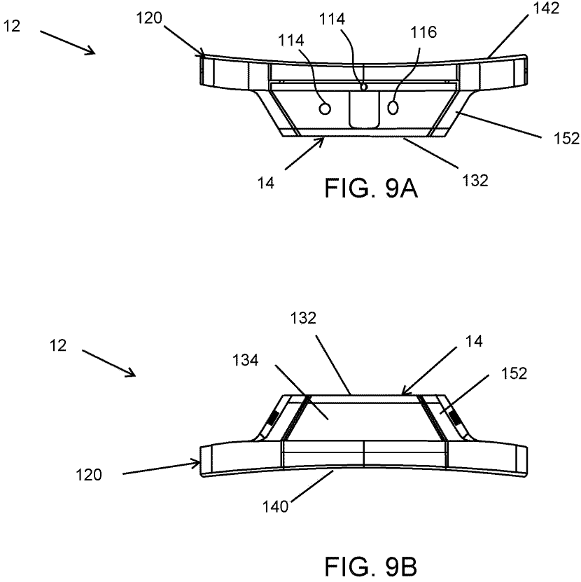

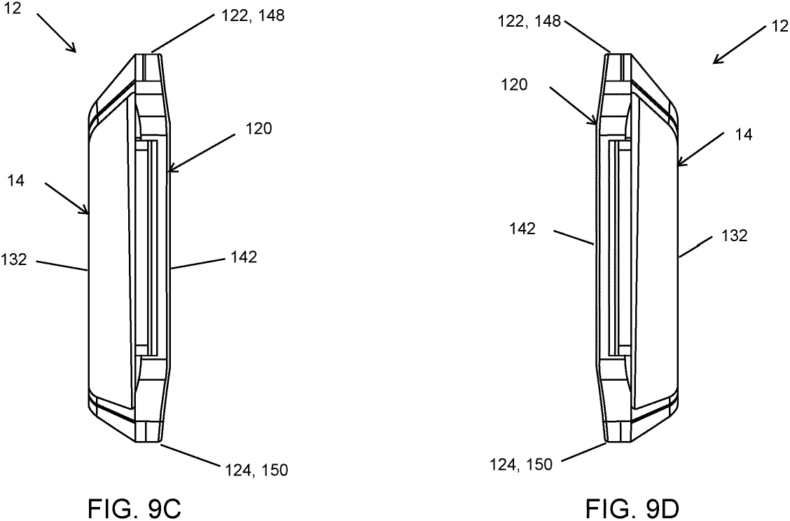

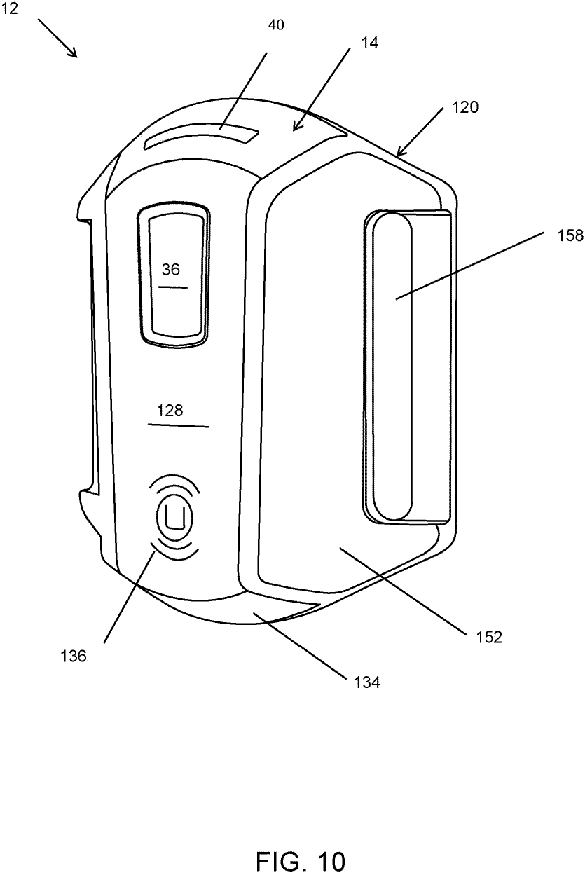

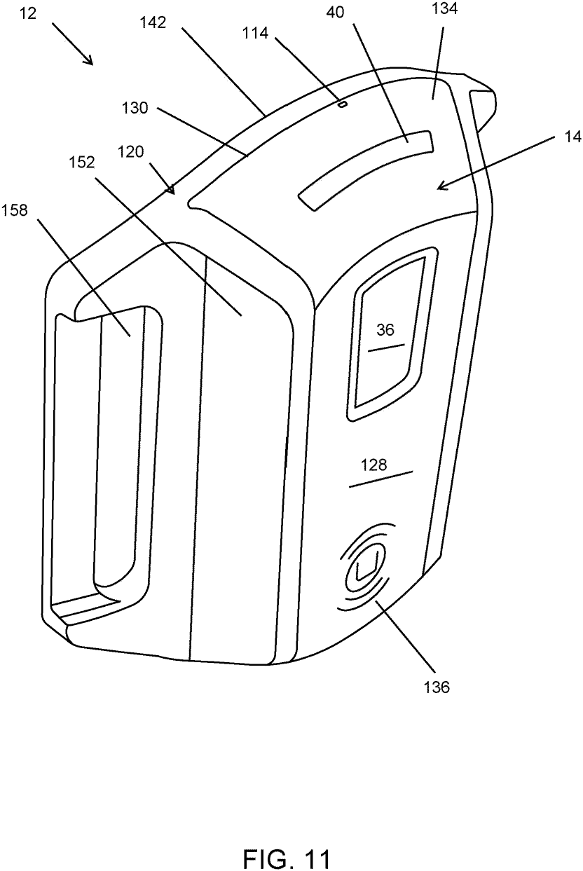

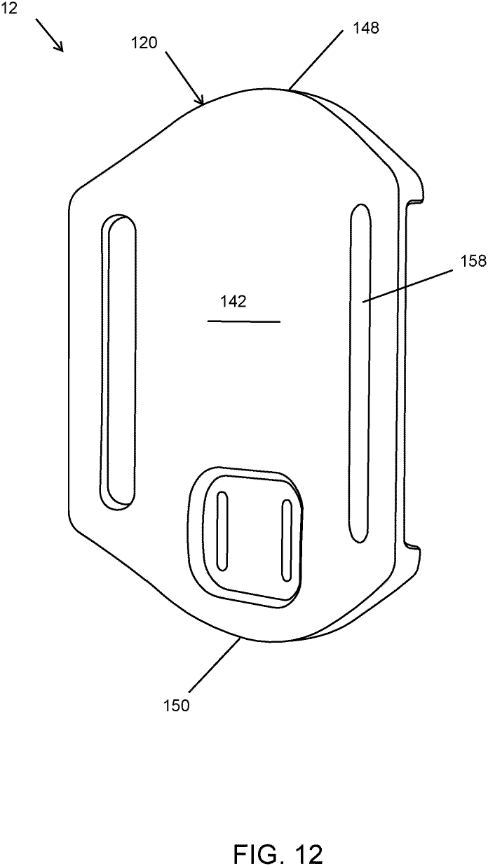

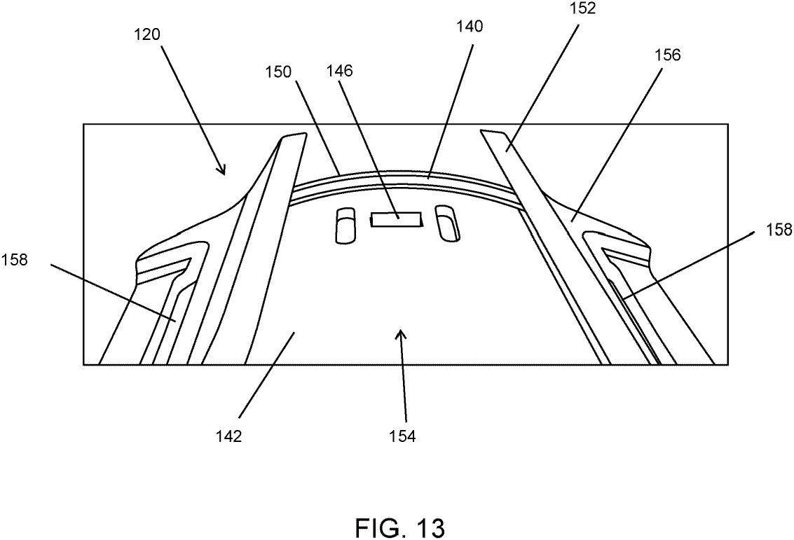

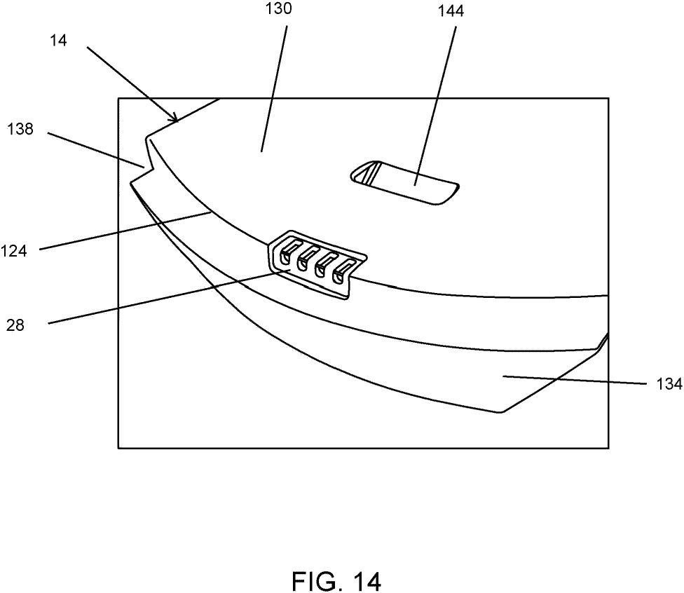

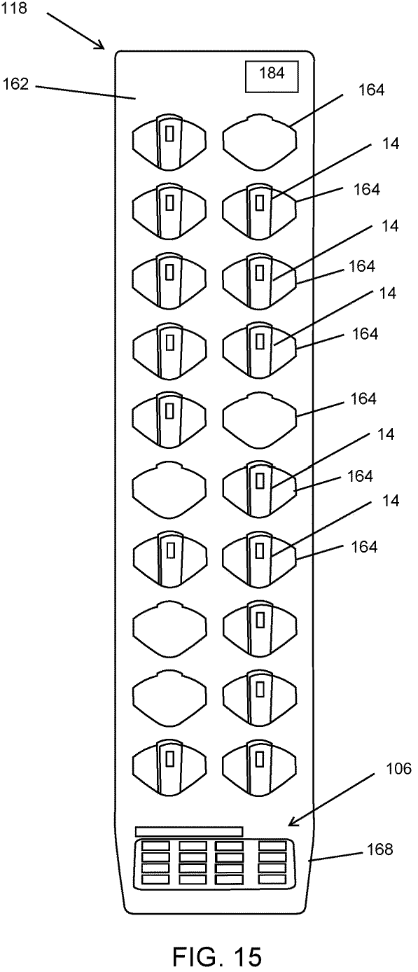

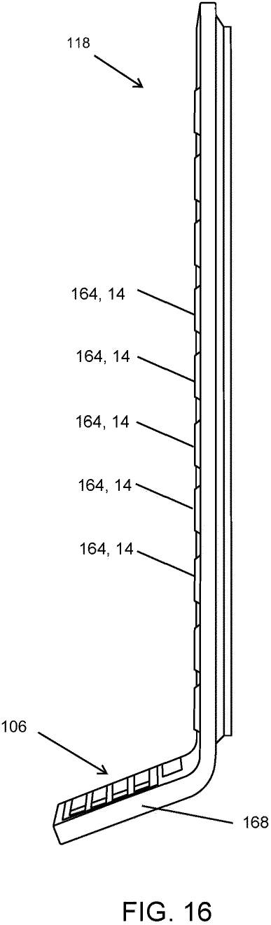

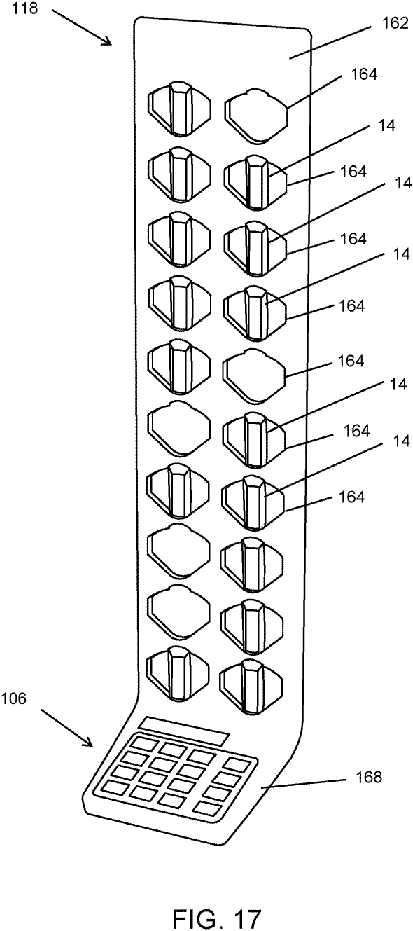

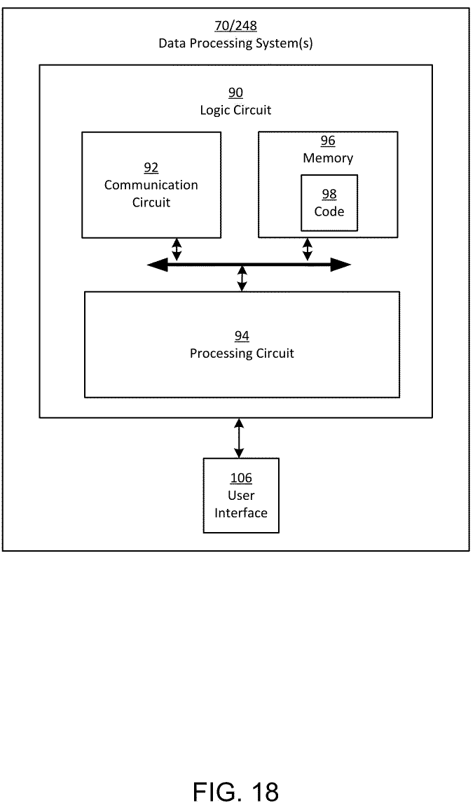

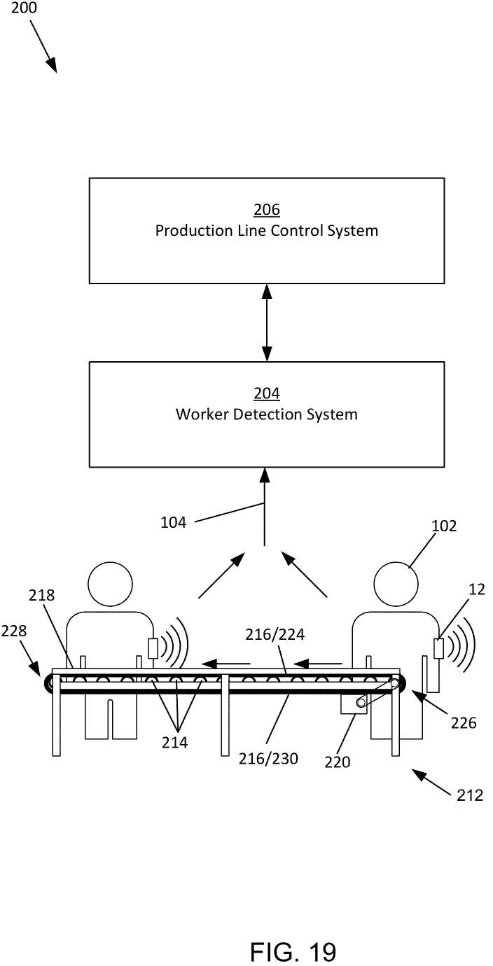

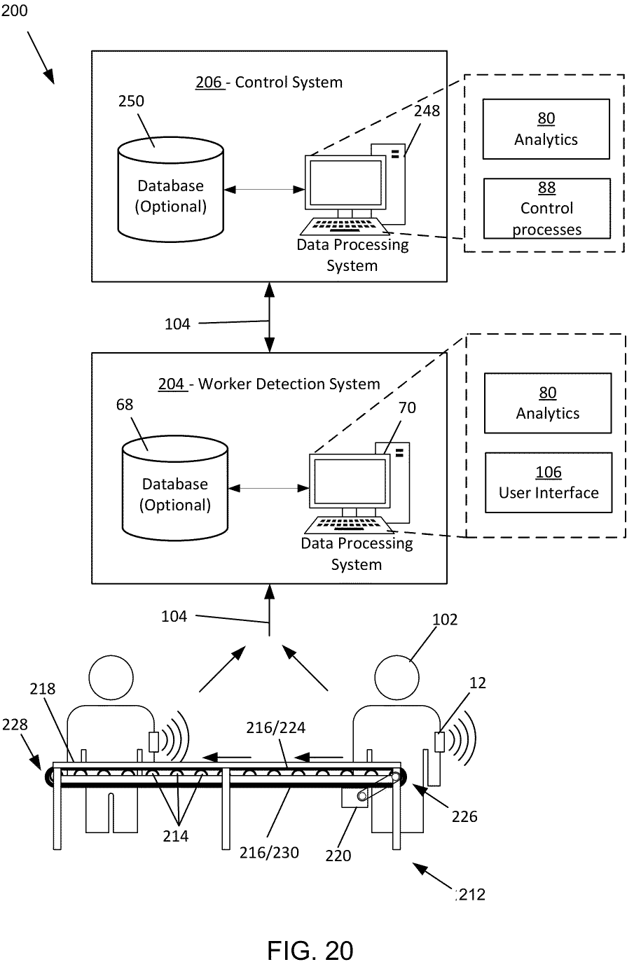

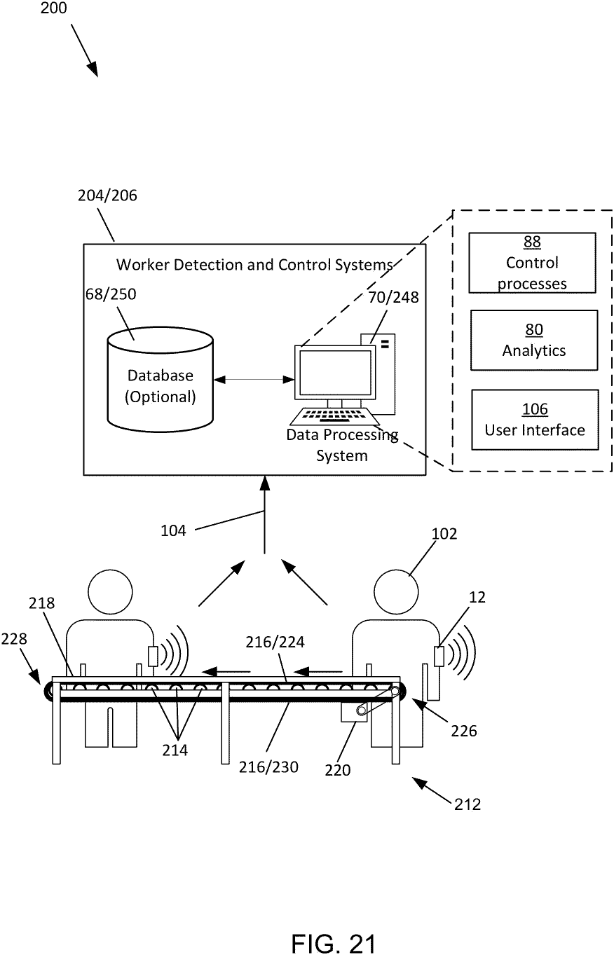

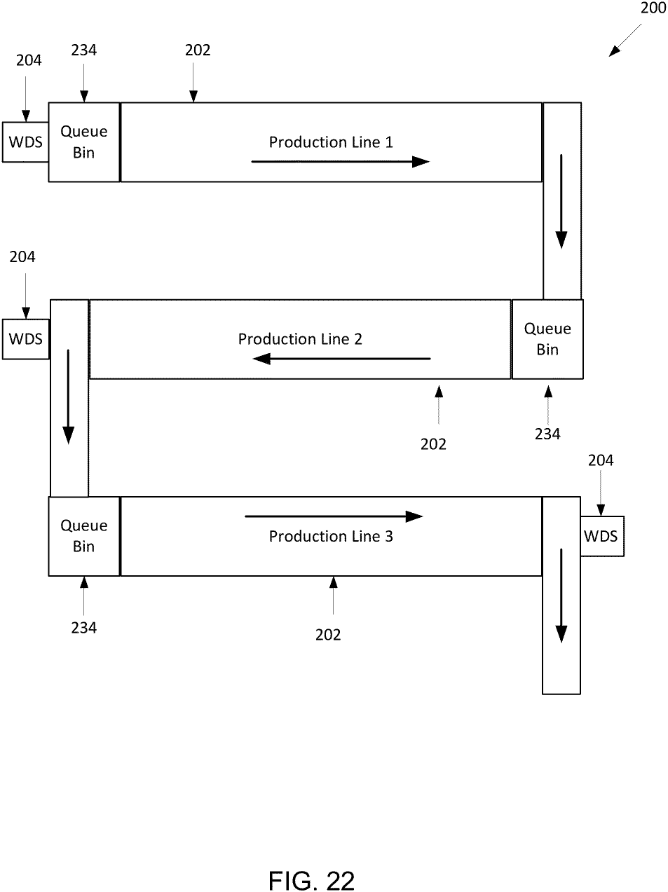

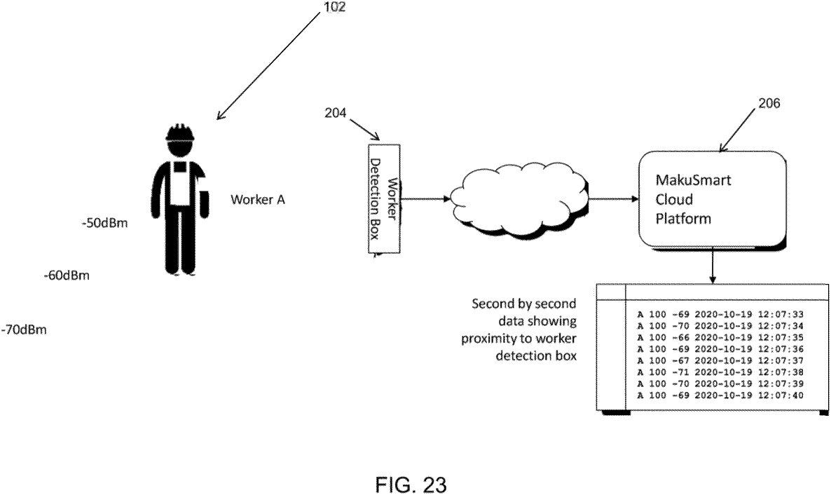

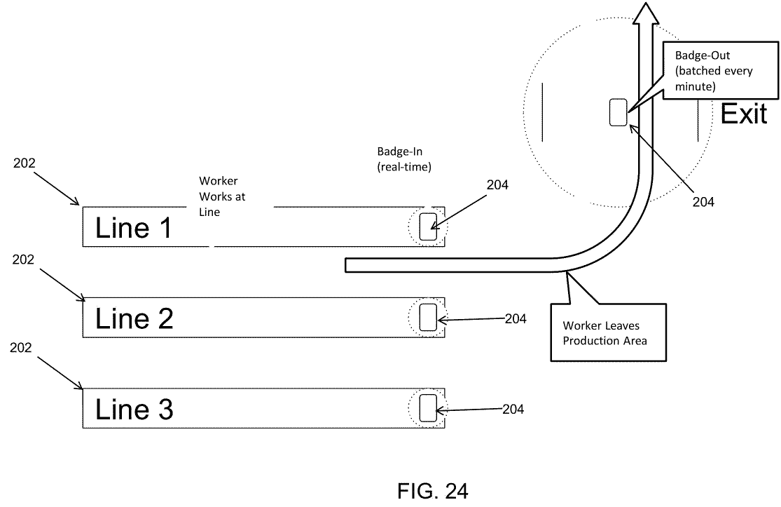

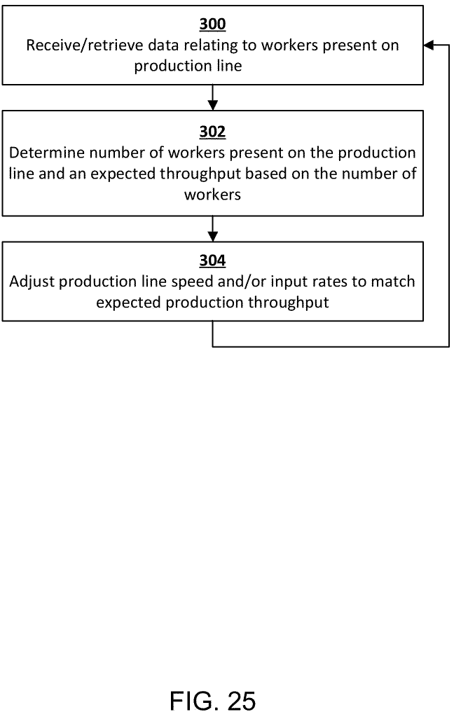

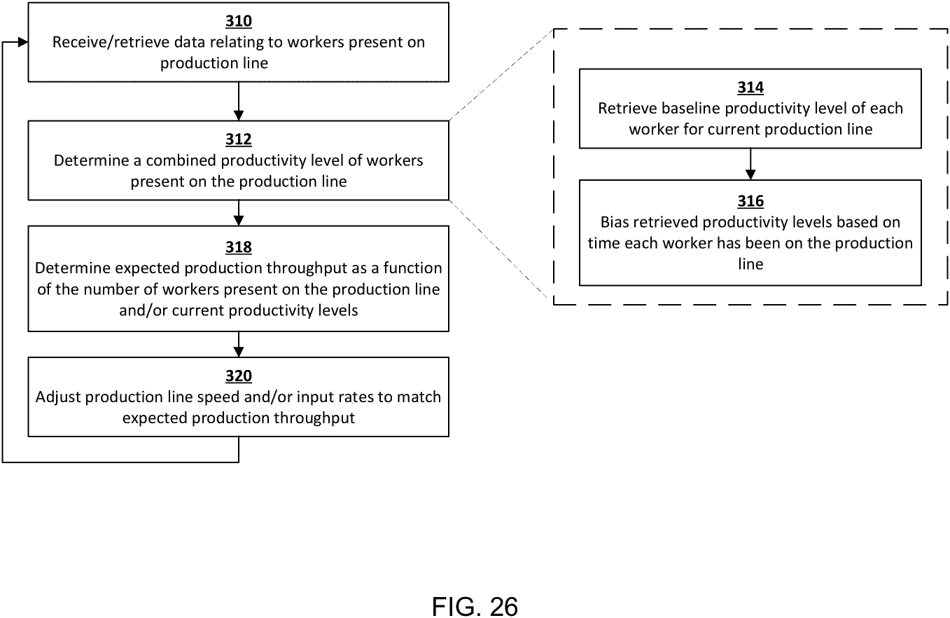

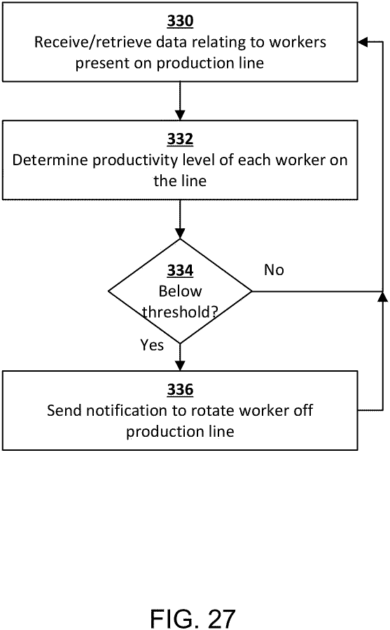

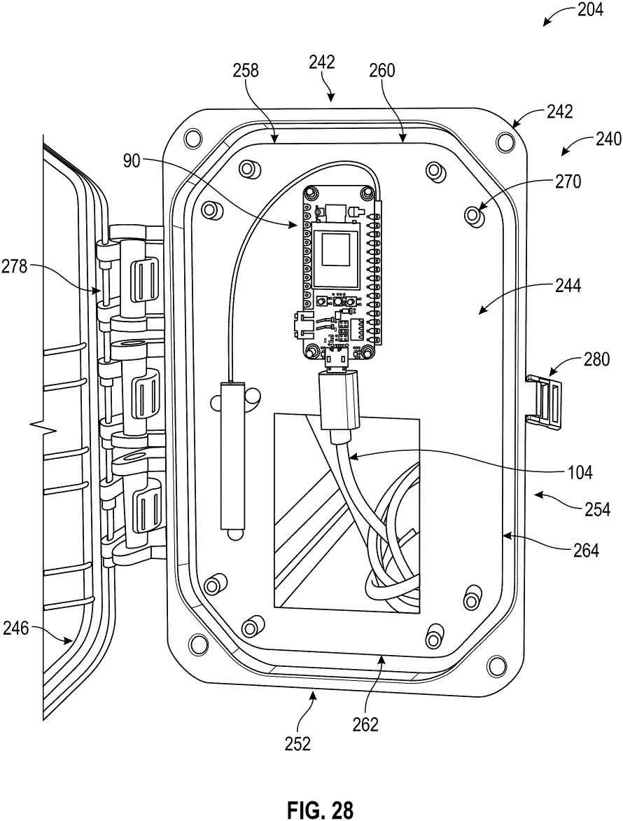

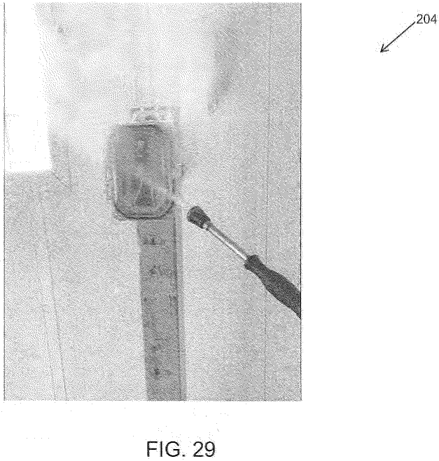

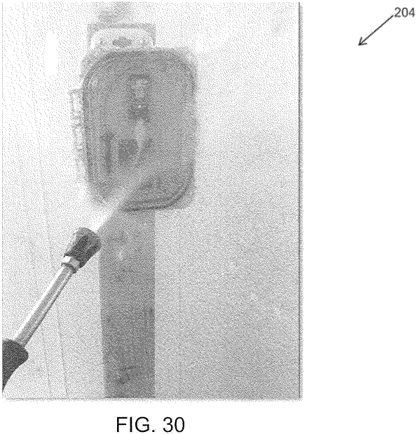

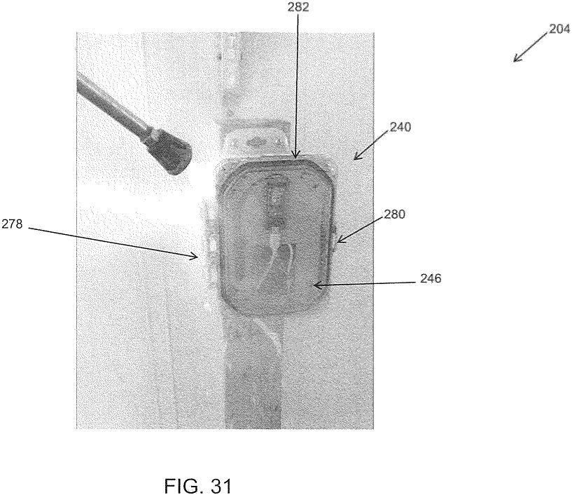

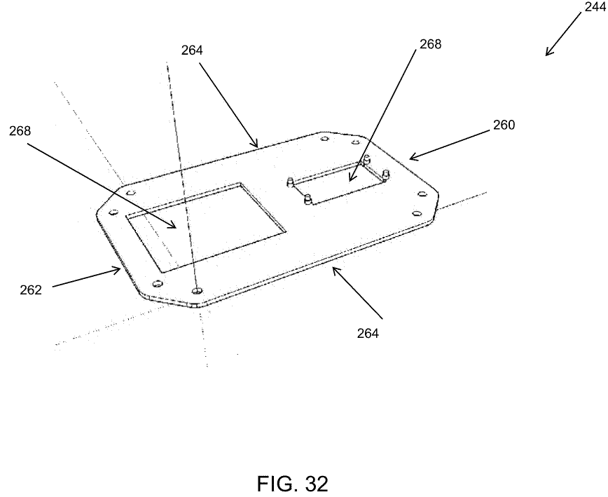

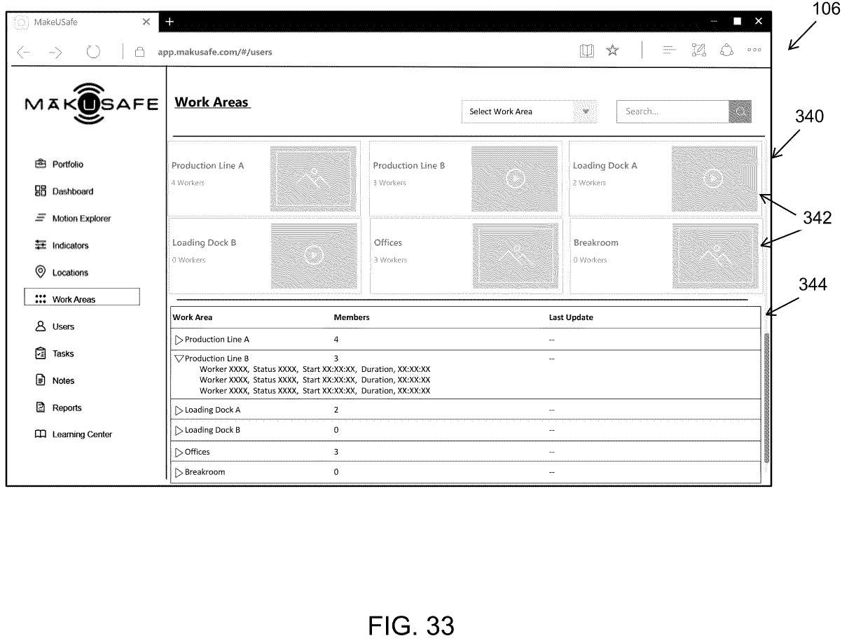

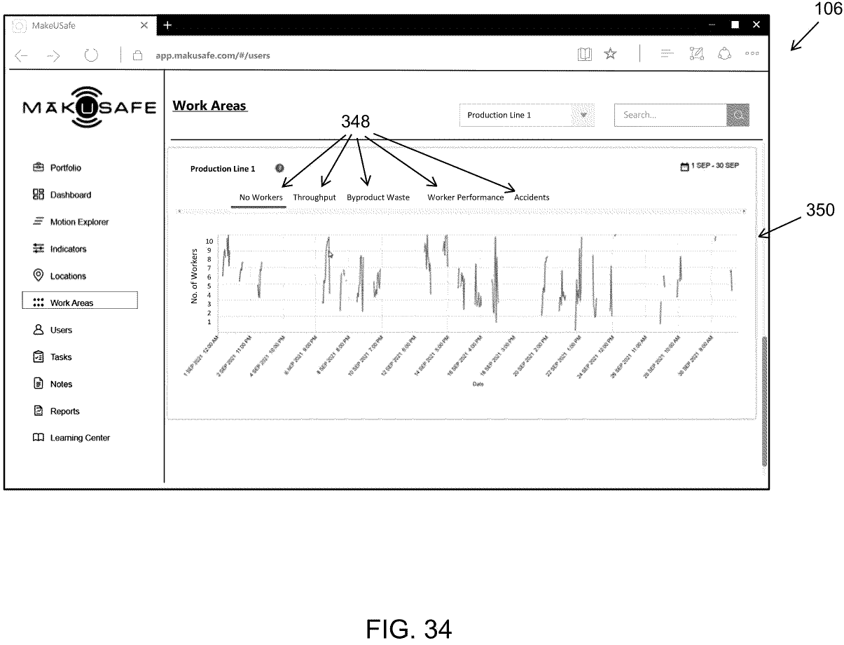

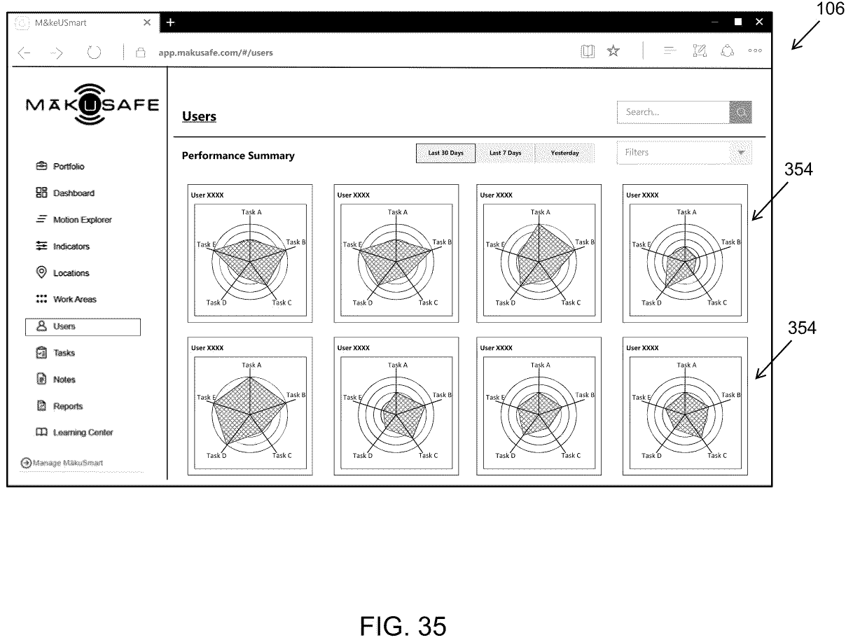

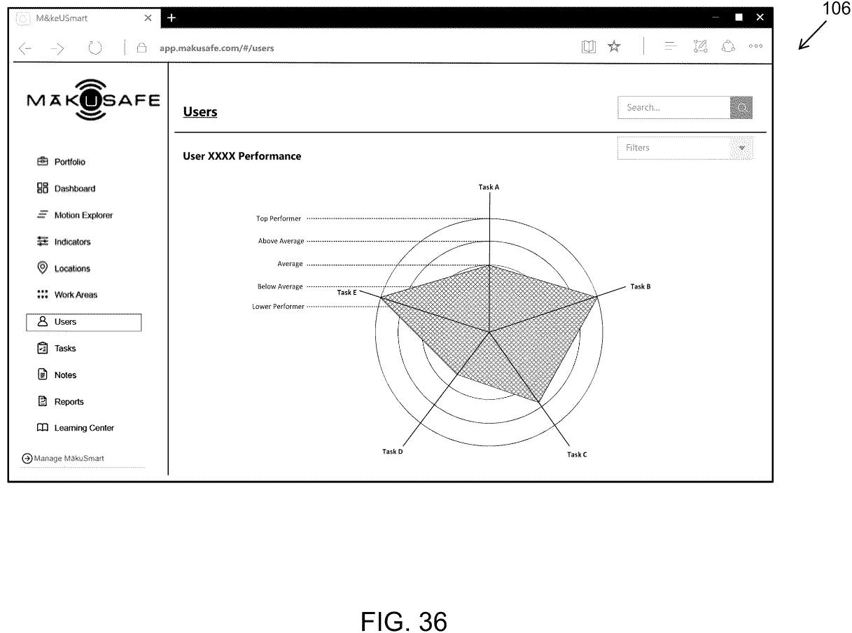

To test the mechanical performance of the microcapsules, a uniaxial compression test was conducted. Typical microcapsules were used with average diameters of 400 µm. In addition, the mechanical performance of fire extinguishing microcapsules manufactured using higher molecular weight of polystyrene were investigated with average diameters of 400 µm. As a control group, the mechanical performance of poly urea-formaldehyde (PUF) shelled microcapsules with paraffin oil cores were also investigated. The investigated PUF shelled microcapsules have average diameters of 250 µm. As seen in FIG. 7, the microcapsules of the present invention exhibit greater mechanical strength than the control group.

To test the fire extinguishing effectiveness, a fire extinguishing composite was manufactured by integrating the fire extinguishing microcapsules formed in this disclosure into an epoxy resin matrix. 9 g epoxy and 3 g curing agent were uniformly mixed in advance, after which 2 g of typical microcapsules were slowly added into the epoxy matrix. The resin was poured into a strip sample and cured at 50° C. for 10 hours. After that, the fire extinguishing tests were conducted by recording the fire extinguishing time after the resin was igniting.

Alternatively, the polymer matrix includes epoxy, polyurethane, polyurea, and silicone rubbers. By introducing the fire extinguisher microcapsules, the flammability of those matrices can be greatly decreased. The microcapsules can be incorporated into a battery by coating on the surface of commercial separators and/or directly mixed with some structural materials in battery packs, such as silicone rubber and glue layers.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. A method of preparing a fire extinguishing core-shell microcapsule by a one-pot oil in water emulsion technique, the method comprising:
dissolving a fluid fluoroketone or hydrofluorocarbon fire extinguishing core material and a polymer shell material into a volatile solvent to form a composite mixture;
emulsifying the composite solution into a polar phase and a non-polar phase by adjusting a concentration of a surfactant to provide interfacial tension tuning; and
evaporating the volatile solvent to precipitate microcapsules having a fire extinguishing material core and a polymer shell and having an average particle diameter of at least approximately 350 microns.

2. The method of claim 1, further comprising incorporating the core-shell microcapsules in a polymer matrix.

3. The method of claim 1, wherein, the volatile solvent is a hydrocarbon solvent.

4. The method of claim 3, wherein the hydrocarbon solvent is one or more of dichloromethane, chloroform, or ethyl acetate.

5. The method of claim 1, wherein said polymer shell is one or more of a polystyrene, a polymethyl methacrylate, a polylactic acid, a polycaprolactone, or a styrenic block copolymer.

6. The method of claim 1, wherein said method of emulsifying the composite solution is carried out under physical agitation in a temperature ranging from 0° C. to 40° C.

7. The method of claim 2, wherein the polymer matrix is selected from one or more of epoxy, polyurethane, polyurea, or silicone rubber.

8. The method of claim 2, further comprising integrating the core-shell microcapsules into a polymer matrix or directly coating them onto the surface of an electronic or battery component.
